(19) United States
(12) Patent Application Publication
(10) Pub. No.: US 2004/0199444 A1
(43) Pub. Date: Oct. 7, 2004

(54) Method of characterizing financial benefits based upon input operational parameters having uncertainties

(76) Inventors: Joel Woodcock, Herminie, PA (US); Robert K. Perdue, Murrysville, PA (US); Clark W. Mycoff, Pittsburgh, PA (US); Theodore a. Meyer, Harrison City, PA (US); Ricardo Llovet, Pittsburgh, PA (US)

Correspondence Address: WESTINGHOUSE ELECTRIC COMPANY, LLC, P.O. BOX 355, PITTSBURGH, PA, 15230-0355, US

(21) Appl. No.: 10/763,127

(22) Filed: Jan. 22, 2004

Related U.S. Application Data
(60) Provisional application No. 60/442,186, filed on Jan. 23, 2003.

(51) Int. Cl. G06F 17/60

(52) U.S. Cl. 705/35

(57) ABSTRACT

An improved method of characterizing the potential financial benefit to a facility such as a nuclear power plant that would result from various groups of possible activities includes determining a number of goals for the facility, identifying groups of activities that could effect achievement of the goal and, for each group of activities, determining a probability distribution on net present savings corresponding with implementation of the group of activities. The method includes identifying a number of operational parameters having an uncertainty and allowing the uncertainty to propagate through the method to provide the probability distribution on net present savings. A plurality of Monte Carlo trials are performed on the operational parameters to result in the probability distribution on net present savings that corresponds with implementation of the group of activities compared with a baseline group of activities.

### CROSS-REFERENCE TO RELATED APPLICATION

The instant application claims priority from U.S. Provisional Application No. 60/442,186 filed Jan. 23, 2003, the disclosures of which are incorporated herein by reference.

### BACKGROUND OF THE INVENTION

1. Field of the Invention

The present invention relates generally to facilities such as nuclear power plant facilities and, more particularly, to a method of characterizing the potential financial benefit to a facility such as a nuclear power plant facility that would result from a number of input operational parameters that each have an uncertainty.

2. Description of the Related Art

Different costs of varying amounts are associated with the operation of a facility such as a nuclear power plant. Among the costs are those associated with various activities such as maintenance activities and other activities that are required to be performed on the facility or that may be desirably performed. As the number of possible activities increases, so increases the complexity in deciding which activities should be performed or implemented as to the facility.

For a complex facility such as a nuclear power plant, various costs are associated with the ongoing operations thereof, and other costs are associated with the various activities such as maintenance activities and other activities that can be performed on the facility. Ordinarily, reduction of such costs would be desirable, such as by delaying the implementation of certain activities, but the consequences that can result from too long of a delay in performing a maintenance activity potentially could be catastrophic and can far outweigh any savings that might have resulted from the delay in implementing the activity.

A need thus exists for a way of characterizing the potential financial effect of performing a number of activities such as maintenance activities on a facility such as a nuclear power plant. However, many of the various operational parameters that would be considered in determining a financial effect have an uncertainty, and some of the operational parameters can vary over time as well as have an uncertainty. Heretofore no model has been provided that enables uncertainties in input operational parameters to be propagated through the model. It is desired, therefore, to provide an improved method of evaluating the potential financial effect of various activities such as maintenance activities to enable choices among various complex strategies.

### SUMMARY OF THE INVENTION

An improved method in accordance with the present invention meets these and other needs. An improved method of characterizing the potential financial benefit to a facility such as a nuclear power plant that would result from various groups of possible activities includes determining a number of goals for the facility, identifying groups of activities that could affect achievement of the goal, and for each group of activities, determining a probability distribution on net present savings corresponding with implementation of the group of activities. The method includes identifying a number of operational parameters having an uncertainty and allowing the uncertainty to propagate through the method to provide the probability distribution on net present savings. A plurality of Monte Carlo trials are performed on the operational parameters to result in the probability distribution on net present savings that corresponds with implementation of the group of activities compared with a baseline group of activities.

Accordingly, an aspect of the present invention is to provide an improved method that enables choices to be made among complex sets of possible activities, such as maintenance activities, that may be performed on a facility such as a nuclear power plant facility.

Another aspect of the present invention is to provide an improved method of characterizing the financial effect of various input operational parameters having uncertainties by allowing the uncertainties to propagate through the method to result in a probability distribution on Net Present Value.

Another aspect of the present invention is to provide an improved method of identifying sets of activities, each set of activities constituting a strategy, and to evaluate the financial effect of implementing each such strategy.

These and other aspects of the present invention are provided by an improved method of characterizing a number of potential financial benefits to a facility, each potential financial benefit resulting from the potential performance of one of a number of groups of possible activities on the facility, in which the general nature of the method can be stated as including determining a number of goals, the achievement or partial achievement of which would affect a financial status of the facility, identifying for each goal a corresponding group of activities, each identified activity affecting in some fashion achievement of the goal, and for each group of activities, determining a probability distribution on net present savings that corresponds with implementation of the group of activities.

Said determining a probability distribution on net present savings that corresponds with implementation of a group of activities may be generally stated as including determining a baseline of activity with regard to the facility, and identifying a number of operational parameters related to the facility that have an effect on the financial status of the facility, with each operational parameter having an uncertainty. Additionally, said determining a probability distribution on net present savings can be generally stated as also including, for each operational parameter, characterizing the operational parameter based upon an assumption of the baseline activity, the characterized operational parameter having an uncertainty and, for each operational parameter, characterizing the operational parameter based upon an assumption of implementation of the group of activities, the characterized operational parameter having an uncertainty. Said determining a probability distribution on net present savings can be generally stated as further including performing a plurality of probabilistic simulation sampling trials on the operational parameters that were characterized based upon the assumption of baseline activity and on the operational parameters that were characterized based upon the assumption of implementation of the group of activities. Additionally, said determining a probability distribution on net present savings can be generally stated as also including determining a net present savings amount for each trial and compiling the net present savings amounts from all of the trials corresponding with the group of activities to form the probability distribution on net present savings that corresponds with implementation of the group of activities. The probabilistic simulation sampling trials may be Monte Carlo trials.

Each said Monte Carlo trial may be generally stated as including, for each operational parameter that was characterized based upon the assumption of baseline activity, generating a random number, the random number determining a baseline value for the operational parameter within its range of uncertainty. Additionally, each said Monte Carlo trial can be generally stated as also including calculating a baseline financial effect on the financial status of the facility on the basis of the baseline operational parameter values, and discounting the baseline financial effect to achieve a present day baseline value. Moreover, each said Monte Carlo trial can be generally stated as further including, for each operational parameter that was characterized based upon the assumption of implementation of the group of activities, generating a random number, the random number determining a strategy value for the operational parameter within its range of uncertainty. Additionally, each said Monte Carlo trial can be generally stated as also including calculating a strategy financial effect on the financial status of the facility on the basis of the strategy operational parameter values, discounting the strategy financial effect to a present day strategy value, and subtracting the present day strategy value from the present day baseline value to determine the net present savings amount for the trial.

### BRIEF DESCRIPTION OF THE DRAWINGS

A greater understanding of the present invention can be obtained from the accompanying Description of the Preferred Embodiment when read in conjunction with the accompanying figures in which:

FIG. 1 is a graph depicting the conditional probability of failure over time for each of an assumption of baseline activities and an assumption of implementation of a set of activities;

FIG. 2 is a graph depicting two probability distribution functions that can be obtained from the aging (increasing) portions of functions of FIG. 1;

FIG. 3 is a schematic depiction of the various input operational parameters that would affect a financial status of a facility, with each operational parameter being characterized as a probability density function based upon an assumption of baseline activity;

FIG. 4 is a schematic depiction of the various input operational parameters that would affect the financial status of the facility, with each operational parameter being characterized as a probability density function based upon an assumption of implementation of the set of activities;

FIG. 5 is a graph depicting an exemplary probability distribution function on net Present Value that would result from implementation of the set of maintenance activities;

FIG. 6 is a flow chart generally depicting the method of the present invention;

FIG. 7 is a flow chart generally depicting a portion of the method of the present invention;

FIG. 8 is a flow chart generally depicting a portion of the method of the present invention; and

FIG. 9 is a schematic depiction of an apparatus which can accept various inputs and can perform the method of the present invention to provide a desired output.

Similar numerals refer to similar parts throughout the specification.

### DESCRIPTION OF THE PREFERRED EMBODIMENT

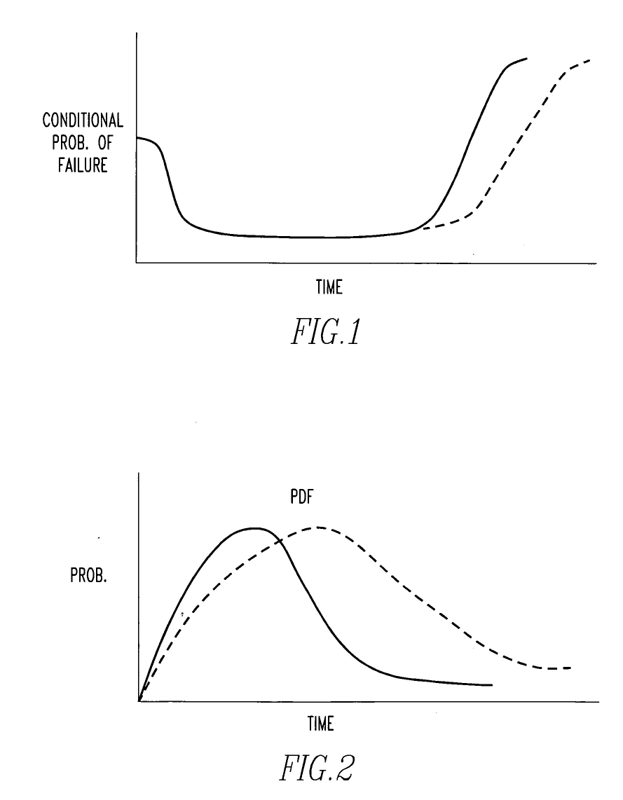

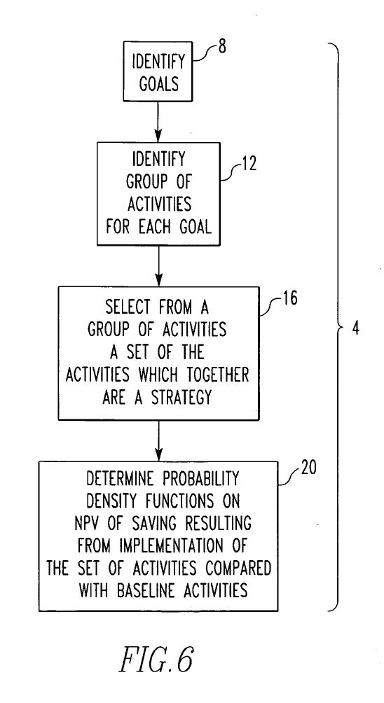

An improved method 4 in accordance with the present invention is illustrated in flow chart form in FIG. 6 and is depicted at least in part in FIGS. 1-5 and 7-9. As will be set forth in greater detail below, the improved method 4 allows various sets of activities, such as maintenance or other activities that may be performed as to a facility such as a nuclear power plant facility or other facility, to be evaluated in order to enable choices to be made among various sets of activities based upon Net Present Value of savings to the facility.

As used herein, the expression “a number of” and variations thereof shall refer broadly to any non-zero quantity, including a quantity of one. As used herein, the expression “activity” and variations thereof shall refer broadly to any action such as performing a task that previously was unscheduled or refraining from performing a scheduled task, and can refer to maintenance activities and numerous types of mitigative or other actions without limitation. As used herein, the expression “facility” and variations thereof shall refer broadly to any entity with which can be associated a financial status, with the financial status being affected by various groups of activities that may be implemented as to the facility and that constitute complex choices.

Broadly stated, the method 4 of the present invention includes determining a number of goals 8 that would affect a financial status of the facility, identifying for each goal a group of activities 12 that could affect achievement of the goal, and for each group of activities determining a probability density function on Net Present Value of savings 20 that would result from, or that could be expected to result from, implementation of the group of activities. A probability density function is a type of function which can be characterized, for example, by a Weibull function.

The determined probability density function on Net Present Value of savings 20 refers generally to the Net Present Value of the cash flows, i.e., the Net Present Value of the savings, that would result from implementation of the group of activities as compared with the cash flows that would result from maintaining a baseline of activities. As used herein, the expression “baseline” and variations thereof shall refer broadly to the activities that are already planned for a facility, and can potentially be referred to as a “do nothing” strategy.

The method 4 can additionally include, for each group of activities, selecting a set of the activities that together form a strategy 16 or that can be said to have a synergy. For instance, a number of the activities can have a combined effect that is greater than the sum of their individual effects, or a number of activities can be relatively easily performed as part of a single transaction. While the method 4 of the present invention is explained in the context of an exemplary facility 72, which is described in the indicated embodiment as being a nuclear power plant, it is understood that numerous other types of facilities can be the subject of the method of the present invention, and that such a facility potentially could even be intangible such as, for instance, an investment portfolio.

The step of identifying goals 8 for the facility 72 involves the identification of various situations, the achievement or partial achievement of which would affect the financial status of the facility 72. For instance, a goal for the facility may be to eliminate outage situations other than those planned for periodic refitting and/or to avoid a situation of extending a period of shutdown beyond that planned for the refitting operation. Such goals would be desirably achieved or at least worked toward since additional outages and extended outages reduce power output and resultant revenues and profits.

For each such identified goal, the next step is to identify every possible activity, the performance of which could affect achievement of the goal. In this regard, an activity could be, for instance, a maintenance activity, and the activity could be either an action that is performed or a previously planned action that is not performed. The identified activities may or may not be otherwise interrelated.

In one embodiment of the method for the present invention, the group of activities associated with a given goal is further evaluated to organize the activities into sets 16, with each set of activities together forming a strategy that may have a synergy, such as when the activities within the identified set of activities may have some type of interrelationship. For instance, a number of tasks that could be carried out substantially simultaneously may together constitute a strategy. Another set of tasks may be related to one another may have a combined effect. For instance, a set of activities might include reducing the temperature of a vessel head and increasing the frequency of inspections of the vessel head in order to reduce possible cracking due to primary water stress corrosion cracking (PWSCC).

It is noted that a set of activities typically will have particular times associated with specific activities. For instance, certain of the activities may be performed at the next scheduled shutdown which, say, could be sixteen months in the future, and other activities could be performed periodically, such as on a semi-annual basis. As such, the strategy typically will be sufficiently defined in terms of future times so that costs, i.e., cash flows, at specific future times or at present can be ascertained relatively accurately within a degree of uncertainty. This facilitates the discounting of future cash flows into present values, as will be described in greater detail below.

The method 4 of the present invention results in a probability density function on Net Present Value of savings 20 associated with the set of activities 16. If a number of sets of activities are evaluated, the result will be a separate probability density function on Net Present Value of savings 20 for each such set of activities. The probability density function on Net Present Value of savings 20 characterizes the potential financial benefit to the facility 72 of performing a given set of activities 16 on the facility 72. The probability density function on Net Present Value of savings 20 is derived from a number of input operational parameters, many of which have an associated uncertainty. Such uncertainties are propagated throughout the method 4 to provide the resultant financial benefit in the form of a probability density function.

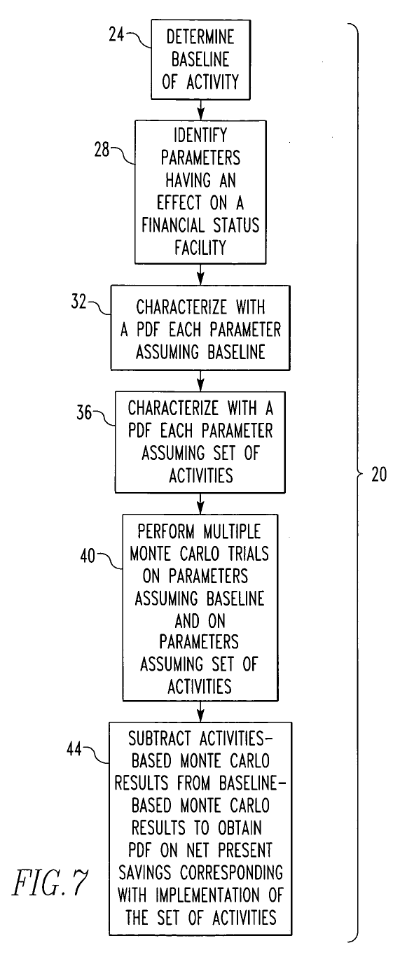

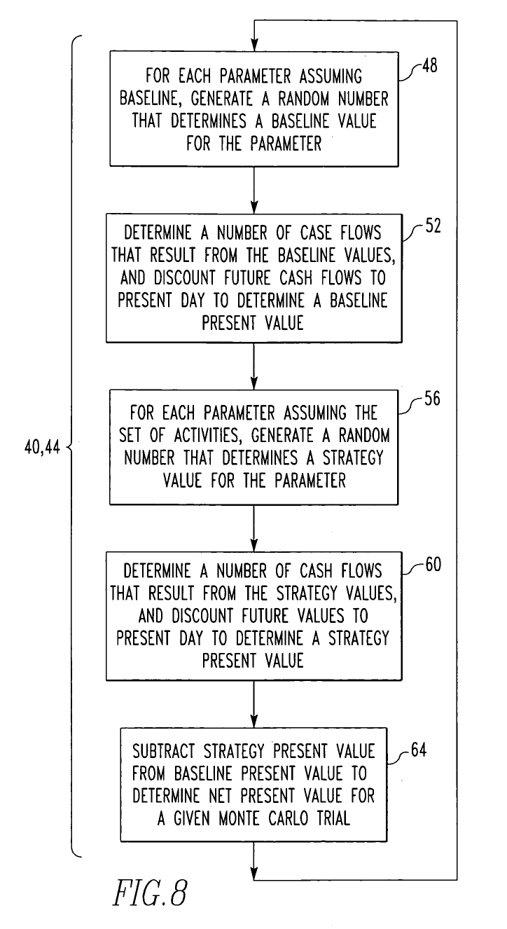

As is depicted in flow chart form in FIG. 7, the probability density function on Net Present Value of savings 20 results from determining a baseline of activity 24 and identifying all of the operational parameters 28 having an effect on a financial status of the facility 72. Such operational parameters can otherwise be stated as being the variables which would be considered in calculating a cash flow. The use of the term “operational” in the expression “operational parameter” is not intended to limit the types of parameters to those that are directly related to “operation” of the facility 72. For example, the price of electricity per MWh would be considered to be an operational parameter if the facility 72 is a nuclear power plant facility, and this is so even though the price of electricity per MWh may be only tangentially related or even unrelated to “operation” of the specific facility 72.

Once the operational parameters, i.e., variables, are identified, the method 4 includes characterizing each operational parameter with its own probability density function based on an assumption of baseline activity 32, characterizing each operational parameter with its own probability density function based on an assumption that a given set of activities would be performed 36, performing multiple Monte Carlo trials 40 on the operational parameters and that have been characterized with probability density functions based upon the two aforementioned assumptions, and compiling 44 the results of the various trials into a probability density function on the Net Present Value of the savings that would result from implementation of the set of activities when compared with the baseline activity. As suggested above, the aforementioned step 20 is performed for each identified set of activities, with the result that each set of activities being considered has associated therewith a probability density function on Net Present Value of savings that would be expected to result from implementation of the set of activities. As used herein, the expression “Monte Carlo” shall be broadly construed to refer to the generic act of sampling in probabilistic simulation and is not meant to preclude of other variants of sampling in probabilistic simulation, such as Latin hypercube sampling, importance sampling or any variance reduction techniques commonly employed with or as a substitute for traditional Monte Carlo sampling.

The determined baseline of activity 24 is the reference level of activity with which an identified set of activities is being compared for resulting financial effect. While the baseline of activity potentially could be characterized as the “do nothing” strategy, it would be more accurately described as the set of tasks that are presently scheduled for the facility 72, such as existing inspection regimens, replacements or upgrades that are planned at a future time, and the like. The baseline of activity 24 may also include doing nothing as to a specific component of the facility 72 until the component fails.

In identifying all of the operational parameters 28 having an effect on the financial status of the facility 72, one desirably would consider every possible operational parameter, even if uncertain, that could be considered when determining a financial status of the facility 72. Each operational parameter may, and likely will, have its own associated uncertainty, and according to the method 4 of the present invention the various uncertainties advantageously are propagated throughout the method to provide a result, i.e., the probability density function on Net Present Value, which has its own uncertainty. One such operational parameter may be, for instance, the probability of failure of a component such as a pump as a function of time. Another operational parameter might be the price of electricity, and another operational parameter may be the cost of disposal, each with its own uncertainty. In the example of the pump, the probability of failure changes as a function of time and additionally has a separate uncertainty.

A failure of the pump may result in an unanticipated or an extended outage that would result in lost energy production which, when multiplied by the cost of electricity, would result in a cost, i.e., a loss, with an associated uncertainty. The cost of disposal may vary with the duration of exposure in a nuclear environment along with its associated uncertainty. The number and variety of operational parameters will vary according to the specific facility being considered, but it would be desired that care be exercised in identifying each and every operational parameter that might bear upon the financial status of the facility 72.

Once all of the possible operational parameters are identified, each operational parameter must be characterized with two separate probability density functions. The first probability density function characterizes the operational parameter based upon an assumption of baseline activity 32. The second probability density function characterizes the operational parameter based upon an assumption of implementation of the set of activities 36.

Such characterizations typically will involve significant engineering resources and may combine various types of data, such as theoretical data, experimental data, and expert opinion data.

FIG. 1 includes exemplary depictions of the conditional probability of failure of a given component based upon an assumption of baseline activity, and also depicts the conditional probability of failure of the same component based upon an assumption of implementation of the set of activities. In this regard, the expression “conditional probability of failure” and variations thereof shall refer generally to the probability of a given event, such as a failure, occurring at a specific time assuming that the event has not previously occurred.

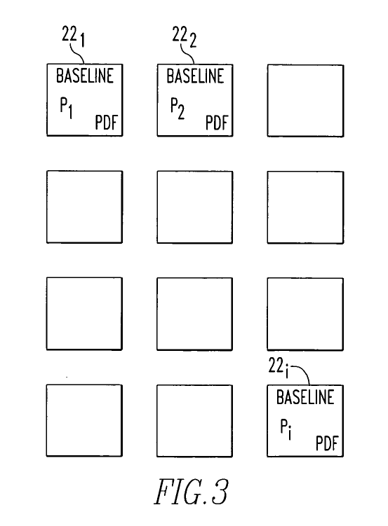

The curves of FIG. 1 can be converted into the probability density function curves of FIG. 2 by performing a Monte Carlo procedure on the curves of FIG. 1 or, more particularly, on the equations that characterize the curves of FIG. 1. The Monte Carlo routine involves repeatedly performing calculations, i.e., performing a large number of trials, with each trial being based on a randomly generated time of conditional probability of failure, all of which enables one to derive a probability density function of failure, such as are depicted in FIG. 2.

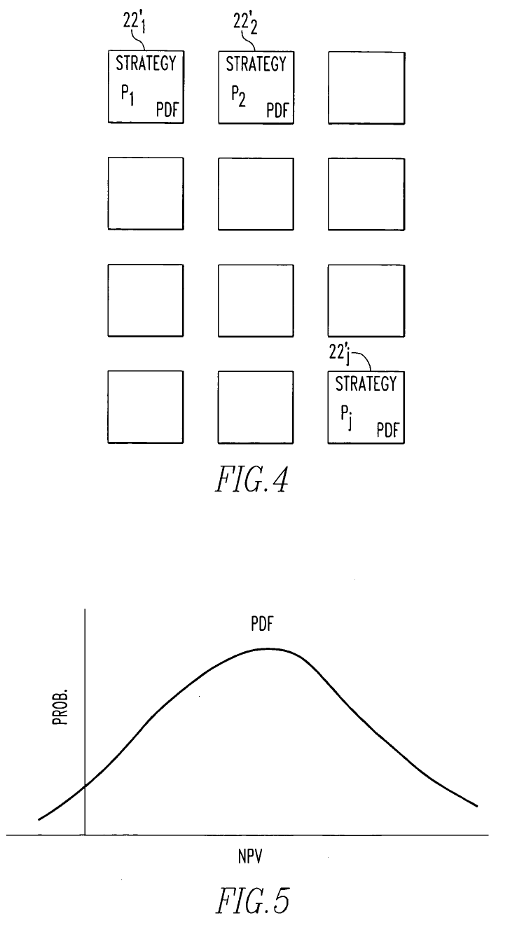

As indicated above, the operational parameters are characterized as a pair of probability density functions, one of which is based upon an assumption of baseline performance, the other of which is based upon performance of the set of activities being investigated. Certain of the operational parameters may be characterized only once, such as if an operational parameter is relevant only to one or the other of the two assumptions, or if the characterization is the same for the two assumptions. FIG. 3 schematically depicts the probability density functions 22₁, 22₂, . . . 22ᵢ for the operational parameters (i in quantity) which have been characterized based upon an assumption of baseline activity performance. FIG. 4 schematically depicts the probability density functions 22′₁, 22′₂, . . . 22′ⱼ for the operational parameters (j in quantity) which have been characterized based upon an assumption of performance of the set of maintenance activities. The number i may be different than the number j.

Once all of the operational parameters are characterized by probability density functions both for the assumption of baseline activity and for the assumption of implementation of the set of activities, as appropriate, Monte Carlo operations 40 are performed on the characterized sets of operational parameters. The Monte Carlo trials are depicted generally in FIG. 8. In any given Monte Carlo trial 40, a random number between zero and unity is generated 48 for each probability density function 22₁, 22₂, . . . 22ᵢ and 22′₁, 22′₂, . . . 22′ⱼ. Each random number represents a probability for which the corresponding value of the variable in question can be calculated using the mathematical inverse of the variable's probability distribution. This fixes for the given trial the value of the operational parameter for which the random number was generated. Specifically, a first portion (i in quantity) of the random numbers results in a fixed baseline value for each of the operational parameters 22₁, 22₂, . . . 22ᵢ, and a second portion (j in quantity) of the random numbers results in a fixed strategy value for each of the operational parameters 22′₁, 22′₂, . . . 22′ⱼ. The random numbers for a given trial thus result in a set of fixed baseline operational parameter values and a set of fixed strategy operational parameter values for the trial.

For each operational parameter, the distribution of random numbers over the course of a plurality of trials follows the probability density function for the operational parameter. Each random number thus fixes the operational parameter (for each trial) within its range of uncertainty.

In any given trial, after the random numbers have been generated and the values of the operational parameters resultingly fixed (for that trial) , the software which implements the method of the present invention then would perform a calculation of the various cash flows 52 that would result from the baseline operational parameter values. For instance, a random number may have been generated to fix the time of failure of the component, which represents the baseline value for that failure operational parameter. Also, a random number may have been generated that determine the price of electricity to establish a baseline value for that operational parameter. In step 52, i.e., for each trial, the software would calculate the present and future cash flows that result from the baseline operational parameter values. Such cash flows may be current cash flows, i.e., representing a replacement cost, and others may be future cash flows, i.e., reflecting ongoing inspection activities. The future cash flows are discounted to present day to determine a baseline present value for the trial.

In discussing cash flows, it is to be understood that a cash flow can represent either a cost or a savings. In the example where the facility 72 is a nuclear power plant facility, many of the calculations of cash flows may focus around lost profits due to lost generation from unexpected down time for the facility, such as from an unexpected failure or from a planned outage that is unexpectedly extended. In such circumstances, the general nature of some of the calculations of cash flows will be to determine, such as from the fixed operational parameters, a duration of downtime and to multiply this duration by the profit from generation which would be expected per unit time, such as determined from the fixed operational parameters, to determine a “lost profits from lost generation” cash flow that would correspond with the downtime. Another cash flow might result from the disposal cost related to the downtime, which might also be a function of when the downtime occurs. These various cash flows are determined from the fixed operational parameters for the trial, and the cash flows are compiled to determine sums of cash flows at the present and at various future times, which sums ultimately are discounted to present day values.

Next, the software would calculate a number of cash flows that would result from the determined strategy values, and future cash flows would be discounted to present day to determine a strategy present value 60. The strategy present value 60 would be subtracted from the baseline present value 52 to generate a Net Present Value 64 for the given Monte Carlo trial.

The aforementioned procedure described above and depicted generally in FIG. 8 would be repeated a sufficient number of times, such as ten thousand times, to generate a large number of Net Present Values 64. For each trial, random numbers would be generated to provide a set of fixed baseline operational parameter values and a set of fixed strategy operational parameter values from which would be calculated a baseline present value 52 and a strategy present value 60, respectively, and the calculated strategy present value 60 would be subtracted from the calculated baseline present value 52 to determine the Net Present Value 64 for the trial.

The large number of trials results in a corresponding number of calculated Net Present Values 64 which together form the probability density function on Net Present Value of savings, which is depicted in an exemplary fashion in FIG. 5. Since the Net Present Value is characterized in the form of a probability density function, it can be seen that the Monte Carlo method has allowed uncertainties associated with the various operational parameters to have been propagated throughout the method to result in an uncertainty for the Net Present Value. One can then analyze the probability density function of FIG. 5, which would be associated with implementation of one set of activities, to determine whether or not the set of activities should be implemented. In making such a determination, it may be desirable to consider not only the potential magnitude of the cost savings but also the degree of distribution on Net Present Value of savings. Additionally, it may be desirable to consider the possibility on Net Present Value being a negative value, meaning that the Net Present Value would be a loss or negative cash flow. In the probability density function depicted generally in FIG. 5, the portion of the curve to the left of the vertical axis describes the probability that implementation of the set of activities would result in a loss. Such a possibility of a loss could be described as a “cost of regret”.

The probability density functions associated with the various sets of maintenance activities are then evaluated to determine which sets of maintenance activities should be performed. The decision might be based on a number of factors including possible risks, uncertainty, and possible savings.

It may also be possible for the probability density function to provide the impetus for performing additional research. For instance, a certain probability density function on Net Present Value of savings may be very widely distributed, and it may be further determined that such distributed values are resulting primarily from the uncertainties of a single or a few operational parameters. It may be desirable to spend additional engineering resources to better characterize the operational parameters based upon baseline performance and upon assumption of implementation of the set of maintenance activities in order to obtain a less distributed, i.e., a more certain probability density function associated with the same set of activities.

It is reiterated that in performing a large number of the Monte Carlo trials of FIG. 8, the distribution of random numbers associated with a given operational parameter are such that the resulting distribution of the baseline values and the resulting distribution of the strategy values each correspond with the probability density function of the operational parameter. For instance, for a given operational parameter, a relatively larger number of the baseline operational parameter values and strategy operational parameter values of the various trials would be values closer to the peak probability of the characterizing probability density function, and relatively fewer baseline and strategy values would be generated at values which the probability density function indicates as being of a relatively reduced likelihood. The baseline values 48 and the strategy values 56 are within the uncertainty of the respective operational parameters.

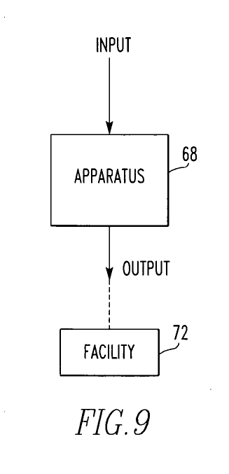

An exemplary apparatus 68 is depicted in FIG. 9. The apparatus 68 receives inputs, such as the baseline values and strategy values, or other values, and produces an output such as a probability density function on Net Present Value that characterizes the financial effect of various sets of activities that can be performed on the facility 72. The apparatus 68 may be a computer or other device and may include software stored within a machine readable medium that performs the functions described herein.

The method 4 of the present invention thus advantageously characterizes in a probability density function on Net Present Value of savings the financial benefit that would be expected to result on a facility based upon the performance or implementation of a set of activities on the facility. Uncertainties in input operational parameter values are propagated throughout the method to result in an uncertainty in the result. The various probability density functions on Net Present Value of savings can then be evaluated to determine whether or not any of the sets of activities should be implemented and/or whether additional studies should be undertaken to further clarify the results.

The results of the method 4 of the present invention are versatile enough to be applied to substantially any facility, the operation of which involves complex choices among actions. In the context of a nuclear power plant, for instance, one software package may be tailored to analyze the various aspects associated with Primary Water Stress Corrosion Cracking (PWSCC) and might include all or many of the various operational parameters that would be considered in calculating a probability density function on Net Present Value of savings that might result from activities intended to ameliorate PWSCC. A separate software package might be developed which is tailored to analyze equipment failure rates and might include the operational parameters one might need to consider in calculating a probability density function on Net Present Value of savings that might result from activities intended to reduce the costs or risks associated with equipment failure. Any number of such software packages may be employed in connection with the various strategies being investigated pursuant to the defined goals.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A method of characterizing a number of potential financial benefits to a facility, each potential financial benefit resulting from the potential performance of one of a number of groups of possible activities on the facility, the method comprising:
determining a number of goals, the achievement or partial achievement of which would affect a financial status of the facility;
identifying for each goal a corresponding group of activities, each identified activity affecting in some fashion achievement of the goal; and
for each group of activities, determining a probability distribution on net present savings that corresponds with implementation of the group of activities.

2. The method of claim 1 wherein said determining a probability distribution on net present savings that corresponds with implementation of the group of activities comprises:
determining a baseline of activity with regard to the facility;
identifying a number of operational parameters related to the facility that have an effect on the financial status of the facility, each operational parameter having an uncertainty;
for each operational parameter, characterizing the operational parameter based upon an assumption of the baseline activity, the characterized operational parameter having an uncertainty;
for each operational parameter, characterizing the operational parameter based upon an assumption of implementation of the group of activities, the characterized operational parameter having an uncertainty;
performing a plurality of probabilistic simulation sampling trials on the operational parameters that were characterized based upon the assumption of baseline activity and on the operational parameters that were characterized based upon the assumption of implementation of the group of activities;
determining a net present savings amount for each trial; and compiling the net present savings amounts from all of the trials corresponding with the group of activities to form the probability distribution on net present savings that corresponds with implementation of the group of activities.

3. The method of claim 2 wherein said performing a plurality of probabilistic simulation sampling trials includes performing a plurality of Monte Carlo trials.

4. The method of claim 3 wherein each said Monte Carlo trial comprises:
for each operational parameter that was characterized based upon the assumption of baseline activity, generating a random number, the random number determining a baseline value for the operational parameter within its uncertainty;
calculating a baseline financial effect on the financial status of the facility on the basis of the baseline operational parameter values;
discounting the baseline financial effect to achieve a present day baseline value;
for each operational parameter that was characterized based upon the assumption of implementation of the group of activities, generating a random number, the random number determining a strategy value for the operational parameter within its range of uncertainty;
calculating a strategy financial effect on the financial status of the facility on the basis of the strategy operational parameter values;
discounting the strategy financial effect to a present day strategy value; and
subtracting the present day strategy value from the present day baseline value to determine the net present savings amount for the trial.

5. The method of claim 4 wherein said characterizing the operational parameter based upon an assumption includes characterizing the operational parameter with a probability density function.

6. The method of claim 5 wherein, for each operational parameter, the random numbers generated over the course of the plurality of Monte Carlo trials result in a set of values for the operational parameter that are distributed in accordance with the probability density function of the operational parameter.

7. The method of claim 2 wherein at least one of the operational parameters with its uncertainty is also known to vary with time.

8. The method of claim 7 wherein said at least one of the operational parameters is an equipment failure rate that is known to vary with time.

9. The method of claim 1 wherein said identifying for each goal a corresponding group of activities includes identifying for each goal a set of activities which together comprise a strategy for achieving the corresponding goal.

10. The method of claim 9 wherein the activities of at least one of the sets of activities together have a synergy.
